(19) United States
(12) Patent Application Publication
(10) Pub. No.: US 2013/0230685 A1
(43) Pub. Date: Sep. 5, 2013

(54) CUSHION DEVICE WITH GEL CENTER

(71) Applicant: Stephanie L. SMITH, Baxter, MN (US)

(72) Inventor: Stephanie L. SMITH, Baxter, MN (US)

(21) Appl. No.: 13/410,795

(22) Filed: Mar. 2, 2012

(51) Int. Cl. B32B 3/00

(52) U.S. Cl. 428/71

(57) ABSTRACT

A cushion includes a center area that is filled with a gel-type material or liquid and is circumferentially surrounded by an outer area that is filled with a beaded-material. In one embodiment, the outer area includes a gel-type material. A bi-directional valve is connected to the outer area to allow only air in or out of the outer area.

### FIELD OF THE INVENTION

The present invention relates generally to cushions and more particularly to pillows.

### BACKGROUND

Individuals with medical conditions sometimes require specialized cushions for resting or sleeping. For example, someone with a head injury or requiring a cerebral shunt/medical device to drain excess fluid from the brain may be limited in how they can rest their heads on pillows due to the pressure of the pillow against the injury or shunt/medical device.

One way to compensate for the extra pressure caused by a firm pillow would be to use a less firm pillow. However, this might not provide enough support for the individual's head in order to provide a comfortable night's sleep. Accordingly, there is a need in the art for a cushion that enables an individual with a head injury or other medical condition to rest their heads without causing undue stress.

### SUMMARY

The present invention encompasses a cushion with varying areas of firmness. A center area is filled with a gel-type material or liquid. An outer area circumferentially surrounds the center area and is filled with a beaded material and, in one embodiment, additionally filled with a gel-type material or liquid. A bi-directional valve is coupled to the outer area and configured to add or remove air from the outer area.

### BRIEF DESCRIPTION OF THE DRAWINGS

FIG. 1 shows a top view of one embodiment of a cushion with a gel center.

FIG. 2 shows a cross-sectional view of one embodiment of the cushion with the gel center.

FIG. 3 shows an inflation/deflation device in accordance with the embodiments of FIGS. 1 and 2.

### DETAILED DESCRIPTION

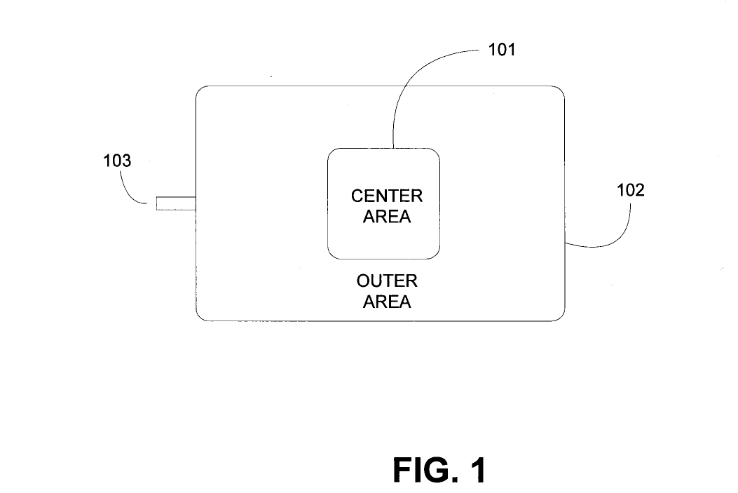

FIG. 1 illustrates a top view of one embodiment of a cushion (i.e., a pillow). The cushion comprises a center area 101 that is circumferentially encircled by an outer area 102. A two-way valve 103 can be used to inflate/deflate the outer area 102.

The center area 101 can be filled with a gel, a gel-type material, or a liquid. The gel-type material or liquid can comprise a silicone gel or some other type of gel material. The liquid might be a highly viscous liquid that provides the same properties as the gel.

The outer area 102 is filled with a beaded material or pellets. In addition to the beads, the outer area 102 can contain a gel, a gel-type material, or a liquid that is mixed in with the beads/pellets. The beads can be polypropylene resin beads, polystyrene beads, foam, or some other beaded material. The gel-type material or liquid that can be added to the beads can be the same gel used in the center area 101 or a different type of gel.

Both the center area 101 and the outer area 102 are individually enclosed in order to keep their respective filling materials separated. The coverings can be any type of material that is appropriate for containing the different areas respective filling materials. For example, rubber, synthetic rubber, vinyl, spandex, or some other synthetic material would contain a liquid or gel-type material. A cotton or linen material would contain beads if the gel-type material was not also used in this area. However, the present invention is not limited to any one type of covering material. Additionally, the entire cushion can be covered with a natural material, such as cotton or linen, that is more comfortable when in contact with an individual's skin.

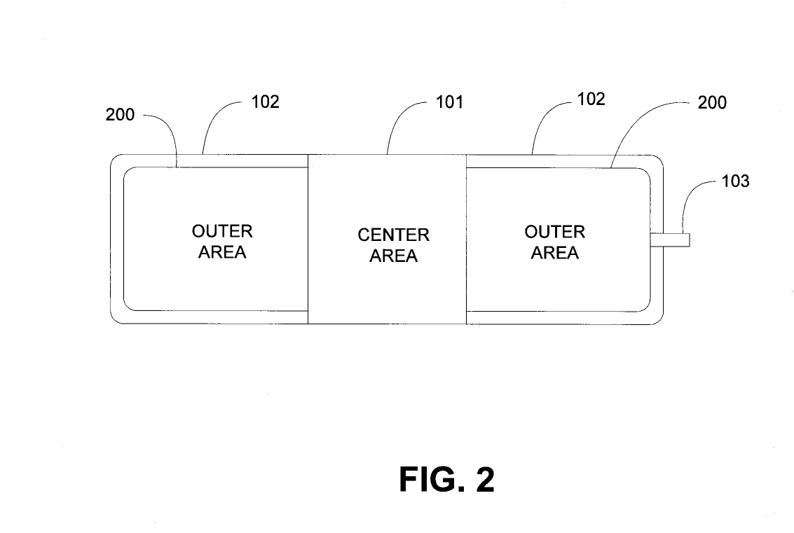

In one embodiment, the outer area 102 includes a perforated second layer of material 200 within the outer covering. The perforated inner covering 200, as shown in FIG. 2, allows the gel or liquid mixed in with the beads to slowly flow through during expansion and contraction of the outer area 102 while being inflated/deflated, as described subsequently.

In one embodiment, the center area 101 is permanently affixed to the center of the outer area 102. In an alternate embodiment, the center area 101 is removable such that it can slide into or out of the center of the outer area 102 and be held in place temporarily by friction or some attachment device (e.g., hook and loop fastener). The alternate embodiment would allow an individual to replace and/or change the different areas of the cushion as necessary depending on a changing medical condition. In another embodiment, the center area 101 might be removed completely to leave just the outer area 102.

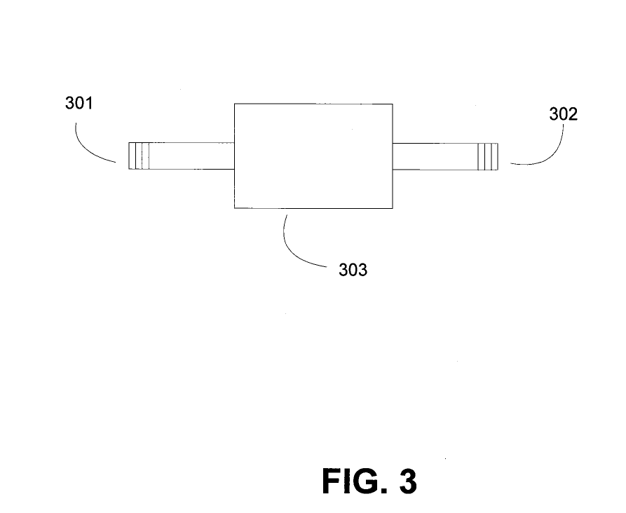

A bi-directional valve 103 is coupled to the outer area 102. The valve 103 enables inflation and deflation of the outer area 102 in order to change the firmness of this area 102. Since the outer area 102 comprises a beaded-material, the valve 103 could include a screen or filter device that allows only air out of the outer area 103 and prevents the beaded material and gel, if present, from exiting. In one embodiment, an inflation/deflation device can be connected to the valve to add or remove air from the outer area 102. Such an inflation/deflation device is illustrated in FIG. 3 and discussed subsequently. In one embodiment, the inflation/deflation device would comprise the screen or filter device to prevent the beaded material and gel, if present, from exiting the outer area.

In an alternate embodiment, the bi-directional valve enables self-inflating and self-deflating of the outer area 102 by opening the valve. For example, in order to reduce the amount of air in the outer area 102, one would open the valve and apply pressure on the outer area 102 to push the air out of the valve then close the valve prior to releasing the pressure on the outer area 102. To re-inflate the outer area 102, the valve could be opened and, based on the type of material in the outer area 102, air would naturally be drawn back into the outer area 102.

FIG. 2 illustrates a cross-sectional view of the cushion of FIG. 1. This view shows the center area 101 that is surrounded only on the sides by the outer area 102. The bi-directional valve 103 then connects to the outer area 102. By surrounding the center area 101 only circumferentially by the outer area 102, an individual's head can come into contact with both areas 101, 102 as necessary, depending on the location of the head injury and/or medical device.

FIG. 3 illustrates one embodiment of an inflation/deflation device in accordance with the embodiments of FIGS. 1 and 2. The inflation/deflation device can be used to add or remove air from the outer area 102 of the cushion. By connecting a first connector 301 of the device to the bi-directional valve of the cushion, air can be added to the outer area by applying pressure to the center region 303. In order to remove air from the outer area 102, a second connector 302 of the inflation/deflation device is connected to the bi-directional valve of the cushion. Connecting the second connector 302 to the bi-directional valve permits both the removal of air and throttling of the rate of air removal by applying pressure to the center region 303 of the inflation/deflation device. For example, once the second connector 302 is connected to the bi-directional valve 103, air would not start exiting the outer area 102 until pressure is applied to the center region 303 of the inflation/deflation device. The amount of pressure applied to the center region 303 determines how fast the air comes out. The inflation/deflation device, in combination with the cushion, would comprise a cushion system.

Numerous modifications and variations of the present invention are possible in light of the above teachings. It is therefore to be understood that within the scope of the appended claims, the invention may be practiced otherwise than as specifically described herein.

What is claimed is:

1. A cushion comprising:
a center area comprising one of a gel-type material or a liquid;
an outer area, circumferentially surrounding the center area, comprising a beaded material; and
a bi-directional valve, coupled to the outer area, configured to allow air in or out of the outer area.

2. The cushion of claim 1 wherein the center area is permanently affixed to the outer area.

3. The cushion of claim 1 wherein the center area is covered with one of a rubber material, a synthetic rubber material, or a spandex material.

4. The cushion of claim 1 wherein the center area is configured to be removable from the outer area.

5. The cushion of claim 4 wherein the center area is temporarily attached to the outer area by one of friction or an attachment device.

6. The cushion of claim 5 wherein the attachment device is a hook and loop fastener.

7. The cushion of claim 1 wherein the outer area further comprises one of the gel-type material or a liquid with the beaded material and an outer covering and a perforated, inner covering that enclose the beaded material and the gel-type material or liquid.

8. A cushion comprising:
a center area covered with a synthetic material and filled with a gel;
an outer area circumferentially surrounding the center area and covered with a synthetic material, the outer area filled with a beaded material and the gel; and
a bi-directional valve coupled to the outer area and configured to allow air in or out of the outer area.

9. The cushion of claim 8 wherein the bi-directional valve allows only air out of the outer area.

10. The cushion of claim 9 wherein the bi-directional valve allows only air out of the outer area in response to pressure applied to the outer area.

11. The cushion of claim 9 wherein the bi-directional valve comprises a filter device or screen configured to keep the beaded material and the gel in the outer area.

12. The cushion of claim 8 wherein the beaded material comprises polypropylene resin beads, polystyrene beads, or foam beads.

13. The cushion of claim 8 wherein the gel is a silicone material.

14. A cushion system comprising:
a center area covered with a synthetic material and filled with a gel;
an outer area circumferentially surrounding the center area and covered with a synthetic material, the outer area filled with a beaded material and a gel;
a bi-directional valve coupled to the outer area and configured to allow air in or out of the outer area; and
an inflation/deflation device configured to be coupled to the bi-directional valve and further configured to increase or decrease an amount of air in the outer area.

15. The cushion system of claim 14 and further comprising a cover that surrounds both the center area and the outer area.

16. The cushion system of claim 15 wherein the cover comprises a natural material.

17. The system of claim 14 wherein the inflation/deflation device comprises a first connector that, when coupled to the bi-directional valve, is configured to increase the amount of air in the outer area

18. The system of claim 17 wherein the inflation/deflation device comprises a second connector that, when coupled to the bi-directional valve, is configured to decrease the amount of air in the outer area.

19. The system of claim 18 wherein the inflation/deflation device further comprises a center region configured to both increase the amount of air in the outer area, in response to applied pressure, and decrease and throttle a rate of air removal from the outer area in response to applied pressure.

20. The system of claim 14 wherein the center area is held within the outer area by friction.
